(19) United States
(12) Patent Application Publication
(10) Pub. No.: US 2006/0215690 A1
(43) Pub. Date: Sep. 28, 2006

(54) Leveraging real-time communications for device discovery

(75) Inventors: Richard A. Wilson JR., Temecula, CA (US); William C. Russell, Laguna Hills, CA (US)

Correspondence Address: Canon U.S.A. Inc.;Intellectual Property Department, 15975 Alton Parkway, Irvine, CA, 92618, US

(73) Assignee: Canon Development Americas, Inc.

(21) Appl. No.: 11/091,612

(22) Filed: Mar. 28, 2005

(51) Int. Cl. H04J 3/16

(52) U.S. Cl. 370/465

(57) ABSTRACT

A system and method for discovering real-time communication protocol enabled devices comprising discovering at least one real-time communication server, logging onto the at least one real-time communication server, retrieving real-time communication protocol enabled device information from the real-time communication server, and automatically adding the retrieved real-time communication protocol enabled device information to a real-time communication protocol contact collection.

### BACKGROUND OF THE INVENTION

1. Field of the Invention

The present invention relates to discovering real-time communication protocol enabled devices and automatically populating real-time communication contact lists with the discovered devices.

2. Description of the Related Art

Data networks have become commonplace for interconnecting various elements such as personal computers, computer peripherals (i.e., printer), servers, etc. The elements making up a data network have traditionally been connected via cables and wires, while more recently the connection has been accomplished wirelessly. Data networks are usually either public networks, such as the Internet, or private, local networks. Typical forms of communications between the elements on the data network include transfer of commands and data, file transfers, and e-mail messages.

Recently, a significant number of people have begun to communicate over data networks using real-time interactive communication protocols. In a real-time communications environment, a user is able to, among other things, communicate with friends and/or co-workers in real-time, receive real-time up-to-date news, or receive notifications from a vendor's web site based on the user's pre-defined settings. It is features such as this that have helped increase the popularity of real-time communication protocols. One aspect of real-time communication protocols that have made them popular is their use of a presence capability. Presence capability allows users who are logged into a particular real-time chat application to know when other parties are available. Presence information typically manifests itself as the “buddy list” or contacts list of a real-time communication protocol.

Currently, in order for one user to be included in another user's “buddy list”, the following procedure must take place. First, if user “A” wishes to be included in user “B's” “buddy list”, user “A” must send user “B” a request requesting permission to be added to user “B's” “buddy list.” If user “B” wants user “A” to be added, then user “B” accepts the request (i.e., grants permission), and user “A” is added to user “B's” “buddy list.” User “B” in turn is automatically added to user “A's” “buddy list.” If user “B” does not want user “A” added to user “B's” “buddy list”, user “B” can just ignore the request. In another approach, user “B” can set user “B's” real-time communication protocol client application to always accept any requests it receives, thus eliminating the need for user “B” to have to go through the process of looking at each request user “B” receives.

There are benefits and drawbacks to each of these methods. In the first case, user “B” is required to examine each and every request to determine whether to include the user sending the request in user “B's” “buddy list.” This process can be very time consuming for user “B”. On the other hand, the benefit of reviewing each and every request is that user “B” has complete control over what users can and can not get on user “B's” “buddy list.”

In the second case, user “B” does not have to examine each and every request user “B” receives, as each request is automatically accepted (i.e., users are automatically granted permission) and the user issuing the request is automatically added to user “B's” “buddy list.” However, on the other hand, blindly accepting all requests can result in unwanted users being added to user “B's” “buddy list”, which can quickly lead to a very crowded “buddy list” as well possible security issues.

Until recently, real-time communication protocols were only being used for communication between users. One early drawback to the implementation of real-time communication protocols was that they only made use of presence information relating to users. In other words, early real-time communication protocols only supported user-to-user communication. As a result, the communication, e.g., the transfer of text messages, photos, etc., occurred only between users, where each user was logged into their respective real-time communication protocol.

Recently, the application of real-time communication protocols has begun to encompass communication between users and devices. For example, real-time communication protocols are being used to send commands to and receive data from various devices. The same principals, i.e., use of real-time communication protocol presence capability, that have been used in the user-to-user environment are applicable in the user-to-device environment. In addition, the use of “buddy lists” is also applicable in the user-to-device environment. However, in this environment, it is currently quite cumbersome for a user to add devices to the user's “buddy list.” First, the user must be made aware of the existence of the device, and then must obtain the device's location information, i.e., IP address, in order to send the device an invitation requesting permission to be added to the device's “buddy list.” In the case where there are multiple devices that the user wishes to send requests to, such as a local area network (LAN) at the user's work location, the user must know of the existence and location of all of the devices and then send separate requests to each device. This process is both cumbersome and time consuming.

Given the popularity of real-time communication protocols, what is needed is a more efficient, less complicated method for requesting permission to be added to a real-time communication protocol enabled device's “buddy list”.

### SUMMARY OF THE INVENTION

The forgoing problem is addressed by a method and system for discovering real-time communication protocol enabled devices and adding the discovered real-time communication protocol enabled devices to a contact list.

More specifically, in an aspect of the present invention, a system and method for discovering real-time communication protocol enabled devices comprising discovering at least one real-time communication server, logging onto the at least one real-time communication server, retrieving real-time communication protocol enabled device information from the real-time communication server, and automatically adding the retrieved real-time communication protocol enabled device information to a real-time communication contact collection.

The present invention allows for easier and more efficient discovery of real-time communication protocol enabled devices and addition of the discovered real-time communication protocol enabled devices to a real-time communication contacts list. A more complete understanding of the invention can be obtained by reference to the following detailed description of the preferred embodiment(s) thereof in connection with the attached drawings.

### BRIEF DESCRIPTION OF THE DRAWINGS

FIG. 1 is a representational view of the general configuration of the system of the present invention.

FIG. 2 is a flowchart describing a process of discovering real-time enabled communication protocol devices and automatically populating real-time communication contact lists with the discovered real-time enabled communication protocol devices according to the present invention.

FIG. 3 is a flowchart describing a user's process of using a discovered real-time communication protocol enabled device after performing the discovery process of the present invention.

FIG. 4 depicts the architecture of an RTC client according to an embodiment of the present invention.

FIG. 5 is an example of performing the discovery process of the present invention.

FIG. 6A is an example of a populated buddy list following the discovery process of the present invention.

FIG. 6B is an example of a populated buddy list after a default period of time associated with one of the entries in the buddy list has expired, according to the present invention.

FIG. 6C is an example of a populated buddy list after a default period of time associated with one of the entries in the buddy list has expired, according to the present invention.

### DETAILED DESCRIPTION OF THE INVENTION

The invention is described by way of an exemplary embodiment, but it is understood that the description is not intended to limit the invention to this embodiment, and is intended to cover alternatives, equivalents, and modifications such as are included within the scope of the appended claims.

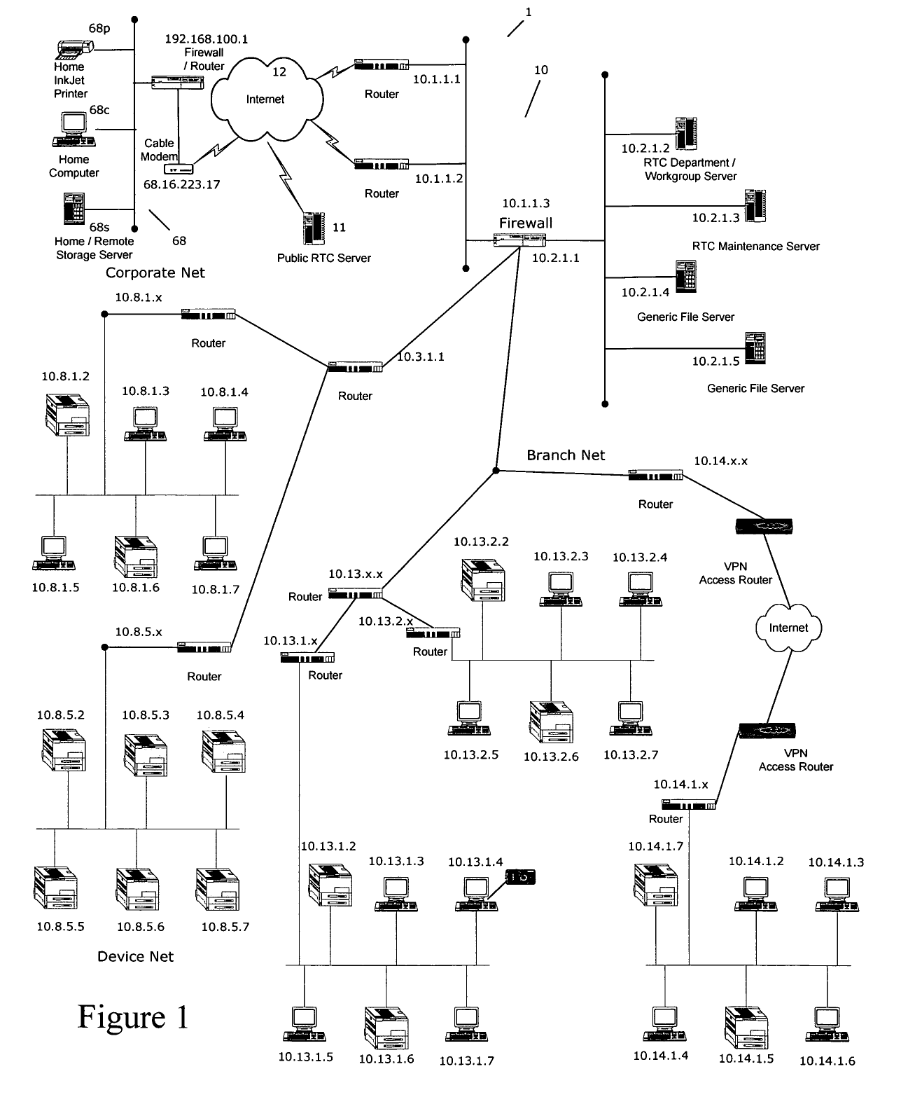

FIG. 1 is a representational view of a system 1 in which real-time communication protocols are used to communicate with real-time communication protocol enabled devices. System 1 includes user device 68c, user device 10.13.2.3, and user device 10.13.1.4, where each of these devices is real-time communication protocol enabled. More specifically, these devices include a real-time communications (RTC) client, which is a computer-executable process, for implementing the real-time communications protocol. The RTC client of the present invention is well known in the art, and therefore a detailed description is omitted herein.

User devices 10.13.2.3 and 10.13.1.4 are part of network 10, while user device 68c is part of home network 68, where network 10 is remote from home network 68. The user devices as depicted in FIG. 1 are personal computers. However, any other real-time communication protocol enabled user device, such as a personal data assistant (PDA), cellular phone (camera and non-camera enabled), etc. that would enable practice of the present invention is applicable.

System 1 also includes various types of real-time communication protocol enabled devices such as home inkjet printer 68p, storage server 68s, network printer 10.8.1.6, and network printer 10.8.5.2. Network printers 10.8.1.6 and 10.8.5.2 are part of network 10, while home inkjet printer 68p is part of home network 68. These devices include not only the same RTC client discussed above, but a real-time device communications (RTDC) client add-on. The RTDC client add-on, which is a computer-executable process, allows real-time communication protocol access to the hardware based features and/or services of the real-time communication protocol enabled devices. For example, a user's real-time communication protocol enabled cellular phone or PDA with an RTDC client would use the RTDC client to signal the RTC client on the user's personal computer that the cellular phone or PDA's battery was getting low. In addition, the user, using the RTC client on the user's personal computer could issue a request to the RTDC client on the user's cellular phone or PDA to provide the cellular phone or PDA's battery status.

Also included in System 1 are Public RTC Server 11, RTC Department/Workgroup Server 10.2.1.2, and RTC Maintenance Server 10.2.1.3. The purpose and functionality of RTC servers is well known in the art and a detailed description is omitted herein. However, for completeness, a brief discussion of how these RTC servers work within the system of the present invention will be provided.

As is known in the art, users of a particular real-time communication service register their credentials (e.g., username and password) with a server of the real-time communication server, i.e., RTC server. By registering, users are then capable of connecting to and communicating with other users of the real-time communication service. This connection and communication process is accomplished by users of the real-time communication service adding other users to their buddy list, thus enabling users to know when the other party is available. In the present invention, not only do users register with an RTC server, but the real-time communication protocol enabled devices also register with the RTC server. Thus, the RTC server allows a user to determine if a particular real-time communication protocol enabled device is present. And, if the real-time communication protocol enabled device is included in the user's buddy list, the user can know whether the real-time communication protocol enabled device is available to be used. Adding the real-time communication protocol enabled device to the user's buddy list is described in more detail below.

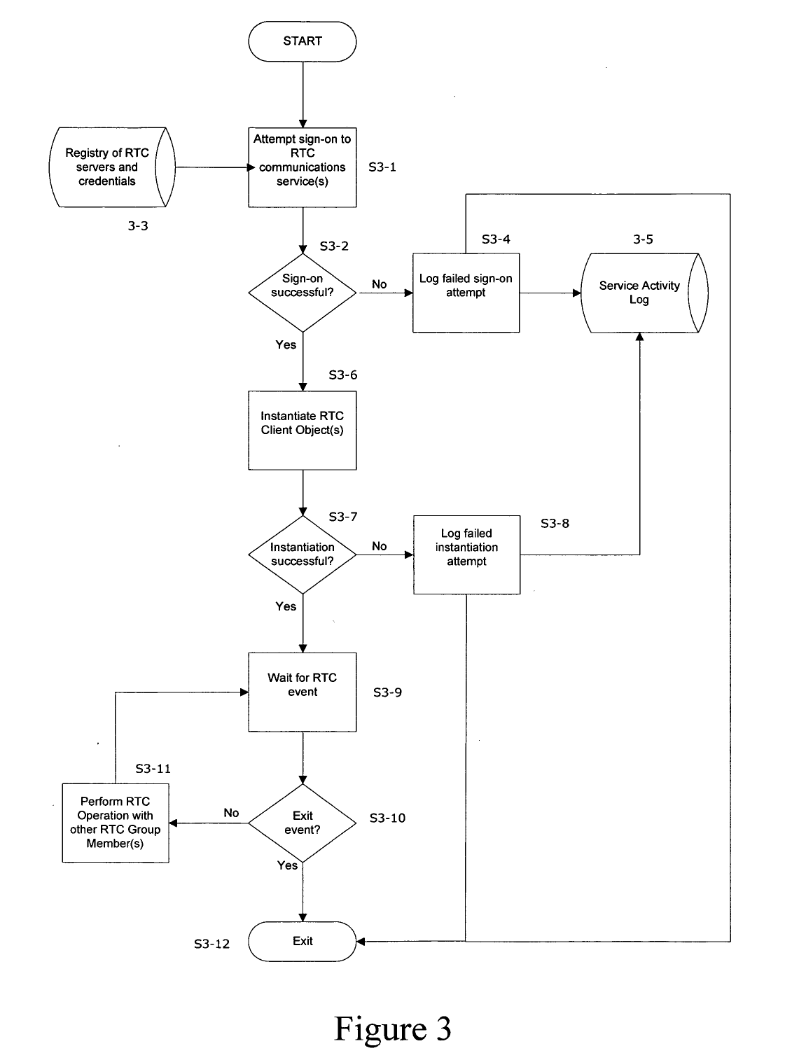

Returning to FIG. 1, Public RTC Server 11 is used to establish connection and allow communication between users and real-time communication protocol enabled devices on home network 68 with the real-time communication protocol enabled devices on network 10. The connection is only available for those users and devices that are registered with Public RTC Server 11. The method of registering is described below with respect to FIG. 3.

RTC Development/Workgroup Server 10.2.1 is used to establish connection and allow communication between users and real-time communication protocol enabled devices on network 10. The connection is only available for those users and devices on network 10 that have registered with the RTC Development[Workgroup Server 10.2.1. The method of registering is described below with respect to FIG. 3.

RTC Maintenance Server 10.2.1.3 is also used to establish connection and allow communication between users and real-time communication protocol enabled devices on network 10. The connection is only available for those users and devices on network 10 that have registered with the RTC Maintenance Server 10.2.1.3. In this case, only those users authorized to perform a maintenance operation and those real-time communication protocol enabled devices that a maintenance operation is allowed to be performed on are registered with the RTC Maintenance Server 10.2.1.3.

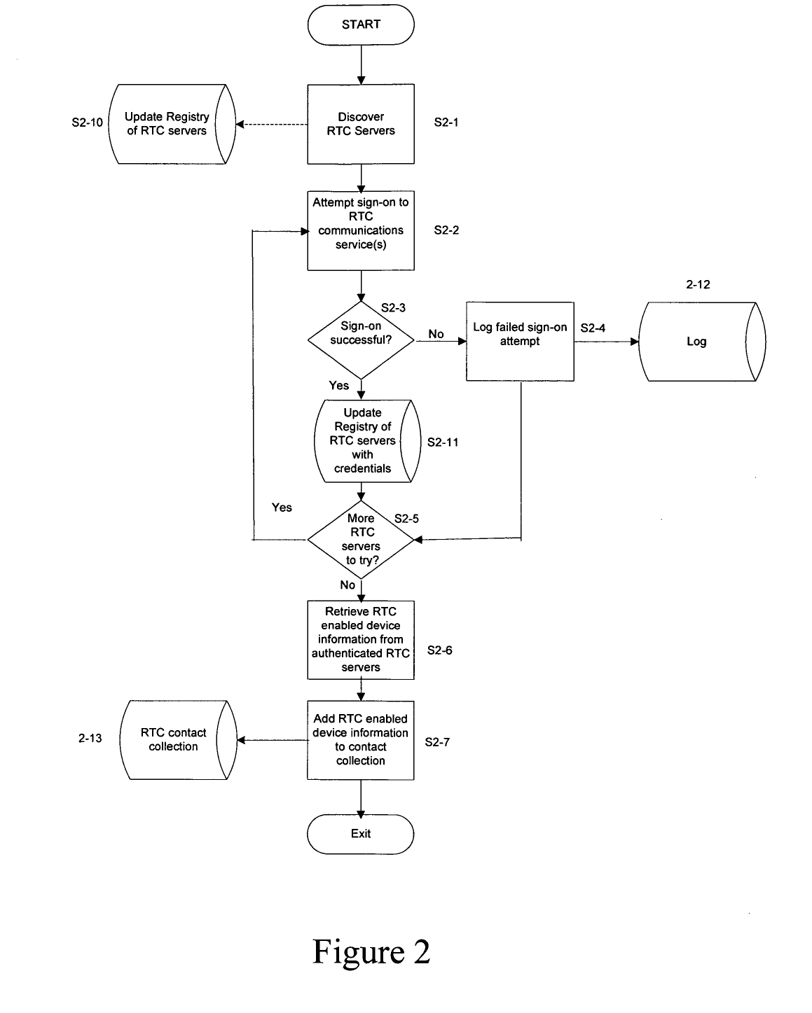

FIG. 2 is a flowchart describing a process of discovering real-time enabled communication protocol devices and automatically populating real-time communication contact lists with the discovered real-time enabled communication protocol devices according to the present invention. Briefly, the process includes discovering at least one real-time communication server, logging onto the at least one real-time communication server, retrieving real-time communication protocol enabled device information from the real-time communication server, and automatically adding the retrieved real-time communication protocol enabled devices information to a real-time communication contact collection.

The process of FIG. 2 described below is applicable to either a user discovering real-time enabled communication protocol devices from a host device, i.e., desktop computer, PDA, cell phone, etc. or another real-time enabled communication protocol device discovering another real-time enabled communication protocol device. For the purposes of describing the process, reference will be made to a user. However, a real-time enabled communication protocol device can be substituted wherever a reference to a user appears.

Turning to FIG. 2, in step S2-1, a user initiates a discovery process to discover existing real-time communication servers. Any known method for discovering devices on a network is applicable. For example, a real-time communication server can be discovered by looking up the real-time communication server in a directory service, or by passively observing network traffic to look for real-time communication protocol traffic, or by attempting to logon to servers within an IP address set and receiving a properly formed rejection notice, or by sending a data packet to a server wherein the data packet is directed to the port on the server associated with real-time communication protocols. These are just a few examples of how a real-time communication server can be discovered, and the present invention is not limited to these examples. Any method of device discovery that would enable practice of the present invention is applicable. Upon discovery of a real-time communication server, the discovered real-time communication server is added to a registry of real-time communication servers in step S2-10, where the registry is located on the user's host device.

After discovery of a real-time communications server in step S2-1, in step S2-2, an attempt is made to log on to the discovered real-time communication server. For example, a user would submit an e-mail address such as user@rtcserver.com. If, in step S2-3, the user successfully logs onto the discovered real-time communication server, then in step S2- 11, the registry of real-time communication servers is updated to include the log in credentials (i.e., usemame and password) associated with the real-time communication server. In addition to the log in credentials, the registry also contains the server address information of the real-time communication server. Next, in step S2-5, a check is made whether there are any additional real-time communication servers discovered in step S2-1 that an attempt to log on needs to be made. If there are additional real-time communication servers, then the process returns to step S2-2. If not, flow proceeds to step S2-6. If, in step S2-3, the log on attempt failed, then in step S2-4, the failed attempt is logged in log 2-12.

Turning to step S2-6, the user retrieves real-time communication protocol enabled device information from all of the real-time communication servers that the user successfully logged onto, i.e., authenticated real-time communication server. The retrieved real-time communication protocol enabled device information includes a real-time communication protocol contact name. This typically consists of a user-name that a user previously registered with the real-time communication server. For a real-time communication protocol enabled device, this would be the name the device provided when the device registered with the real-time communication server. The contact name is normally what appears in the user's (or device's) buddy list.

When retrieving the real-time communication protocol enabled device information, the user is only able to retrieve the device information for those real-time communication protocol enabled devices for which real-time communication protocol enabled device information retrieval is allowed. For example, in certain circumstances, access to a particular device is restricted for certain users. Take the case of a person visiting a company (visitor) for a meeting. In order to facilitate the visitor transferring information to meeting participants, such as printing or transmitting documents, it would be convenient for the visitor, whose laptop computer has a real-time communication protocol client, to access some, but not all of, the company's real-time communication protocol enabled devices, like a printer.

Since the company, for security purposes, would normally want to restrict visitor access to only certain devices, the company's system administrator can set the access information for each of the company's real-time communication protocol enabled devices such that visitors can only access a handful of real-time communication protocol enabled devices. This type of access restriction can be accomplished by setting up guest accounts on only the real-time communication protocol enabled devices that the company wishes to allow visitors to access. Under these circumstances, when attempting to retrieve real-time communication protocol enabled device information in step S2-6, a visitor would only be able to retrieve the information from those real-time communication protocol enabled devices that have guest accounts. The devices without guest accounts would be invisible to visitors.

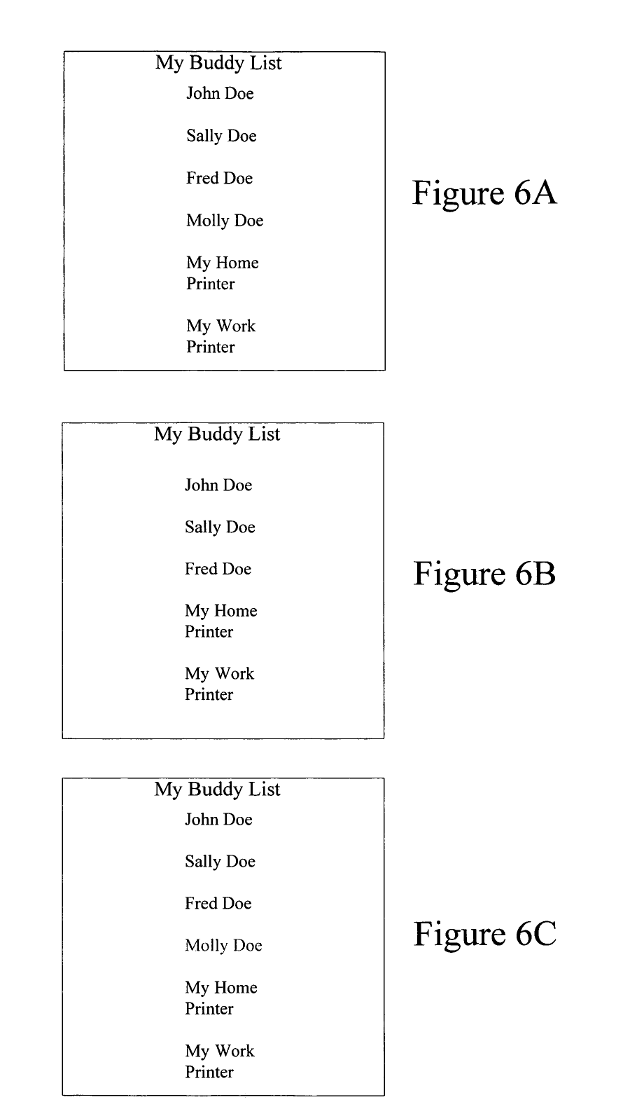

Once all of the real-time communication protocol enabled device information has been retrieved from all of the authenticated real-time communication servers, flow proceeds to step S2-7. In step S2-7, the retrieved real-time communication protocol enabled device information is added to the real-time communication contact collection 2-13 located on the user's host device. The real-time communication contact collection 2-13 contains all of the information the user requires to initiate a real-time communication session with another user or device. This information can be stored on the user's host device in a number of different formats, for example, a database. The information typically manifests itself to the user on the host device's display as the user's buddy list. FIG. 6A depicts a populated buddy list following the discovery process described above.

Next, in step S2-8, the user selects a real-time communication protocol enabled device from the buddy list generated from the real-time contact collection 2-13, and initiates a desired operation. For example, from FIG. 6A, a user selects “My Home Printer” from the user's buddy list displayed on the user's camera enabled cellular phone and then proceeds to print a digital image from the camera on the real-time communication protocol enabled printer associated with “My Home Printer.” Other operations can include faxing, scanning, or data storage.

Upon completion of all activities associated with a particular real-time communication server, i.e., retrieving real-time communication protocol enabled device information and/or initiating an operation with a real-time communication protocol enabled device, in step S2-9, the user logs off the real-time communication server.

In another embodiment, in step S2-7, when the retrieve real-time communication protocol enabled device information is added to the real-time communication contact collection 2-13, the device information is added for a default period of time. That is, the device information will only be stored in the real-time communication contact collection 2-13 for a default period of time, and upon expiration of that time, the device information will automatically be removed from the real-time communication contact collection 2-13. Removal of the device information from the real-time communication contact collection 2-13 results in the associated contact name appearing in the user's buddy list being removed from the buddy list. For example, in FIG. 6A, the default period of time for “Molly Doe” has not yet expired, while in FIG. 6B, the default period has expired. In another embodiment, instead of the associated contact name being removed from the buddy list, the name remains in the buddy list but is rendered inaccessible, i.e., grayed out, as shown in FIG. 6C.

Currently, the addition and deletion of contact names from a buddy list must be done manually. Since numerous contact names can be added to a buddy list during the course of using a real-time communication protocol application, over time, a buddy list can become very large. In many instances, it can contain old and/or outdated information. This makes manually managing a user's buddy very cumbersome and burdensome. This is especially true for real-time communication protocol enabled devices, since a user may not easily be able to manually manage the real-time communication protocol enabled device's buddy list. By adding the contact name for a default period of time, management of the buddy list, especially for real-time communication protocol enabled devices, becomes easier. In another embodiment, the default period of time is modifiable. This provides flexibility for maintaining a particular contact name in a buddy list for a desired time that may be less than or greater than the default time period.

In yet another embodiment, step S2-1 can be omitted where the user only wishes to discover any new real-time communication protocol enabled devices that are associated with a previously discovered real-time communication server and does not wish to discover any new real-time communication servers and/or their associated real-time communication protocol enabled devices.

FIG. 3 is a flowchart describing user's process of using a discovered real-time communication enabled protocol device after performing the discovery process described above. This process can either occur in conjunction with the discovery process or subsequent to the discovery process. If the process of FIG. 3 occurs in conjunction with the discovery process, then steps 3-1 through 3-5 of FIG. 3 and steps 2-2 through 2-4 and step 2-12 of FIG. 2 are one in the same. For the purposes of describing the process of FIG. 3, reference will be made as if the process is performed after the discovery process.

Turning to FIG. 3, in step S3-1, a user attempts to log/sign onto a real-time communications service server. As previously discussed, logging in/signing onto a real-time communications service server typically consists of the user providing previously established membership credentials, where these credentials are typically a user name and password. The registry of real-time communications servers and credentials (3-3) contains the server address information and credentials for logging/signing onto the real-time communications service servers of which the user is a member.

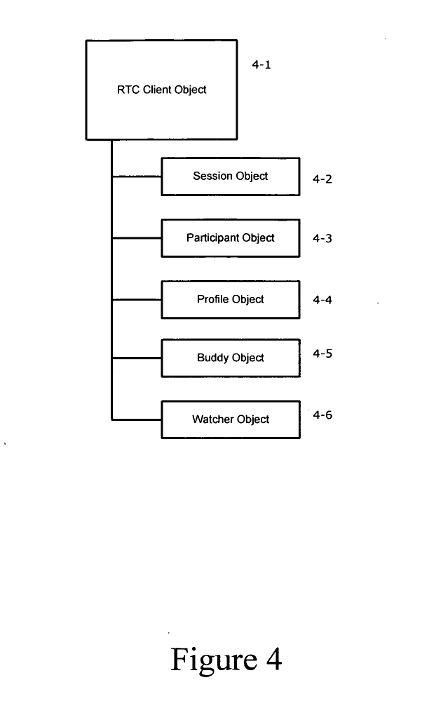

Next, in step S3-2, a determination is made whether the user successfully logged onto the real-time communication server. This determination is typically performed by comparing the credentials provided in step S3-1 with those stored in the registry of real-time communication servers and credentials 3-3. If the log/sign on fails, flow proceeds to step S3-4, where the failed log/sign on attempt is logged in the service activity log (3-5). If the user successfully logs/signs onto the real-time communications service, flow proceeds to step S3-6, where the real-time communications client objects and sub-objects, as described in FIG. 4 below, are instantiated and prepared on for example, user devices 68c, 10.13.1.4, and 10.14.1.4 to process requests.

FIG. 4 depicts the architecture of the RTC client as it appears on user devices 68c, 10.13.1.4, and 10.14.1.4. In more detail, RTC Client Object 4-1 contains the overall bookkeeping information for the real-time communication service client (i.e., user device) and the other objects, including the following described objects. Session Object 4-2 manages the real-time information communication service session, including session initiation, answering, terminating, and adding participants, etc. Participant Object 4-3 manages/contains a session participant, including participant state information, name, etc. Profile Object 4-4 contains the bookkeeping information for the client (i.e., user device) and manages such information as display name, user name, supported session types, network resources, and accounts, etc. Buddy Object 4-5 manages contact information and status. Watcher Object 4-6 manages information about the state of a “watcher”, i.e., entities that have added this object as a contact.

Returning to FIG. 3, after the RTC client object 4-1 and all sub-objects (4-2 through 4-6) are instantiated in step S3-6, in step S3-7, it is determined whether the instantiation was successful. If the instantiation fails, flow proceeds to step S3-8, where the failed instantiation attempt is logged in the service activity log (3-5). If the instantiation is successful, flow proceeds to step S3-9, where the process waits for an RTC event. RTC events include, among other things, an indication from a member of the user's buddy list that the member is available for establishing a real-time communication session.

In step S3-10, a check is performed whether to exit the event that occurred in step S3-9. If the event is not to be exited, flow proceeds to step S3-11, where a real-time communication operation is performed with other real-time communication service group members, i.e., a member on the user's buddy list. For example, a user selects “home inkjet printer” 68p from the user's buddy list on network computer 10.13.1.4 and proceeds to print a digital image from network computer 10.13.1.4 on “home inkjet printer” 68p. In another example, a user selects “home inkjet printer” 68p from the user's buddy list displayed on the user's camera enabled cellular phone (not shown) and then proceeds to print a digital image from the camera on “home inkjet printer” 68p. Other operations can include faxing, scanning, or data storage.

Upon completion of all activities associated with a particular real-time communication server, i.e., retrieving real-time communication protocol enabled device information and/or initiating an operation with a real-time communication protocol enabled device, flow proceeds to step S3-12, where the process ends, i.e., the user exits the real-time communication service.

In another embodiment, the operation performed in step S3-11 can be restricted. For example, operational restrictions can be used to limit the number of pages that can be printed at a particular printer, limit the amount of data that can be stored at particular storage location, etc. Other types of operational limitations can include access count, time-of-day, or any other operational restriction that would enable practice of the present invention. In the case of real-time communication protocol enabled devices, these restrictions can be set based on the type of device and capabilities of the device.

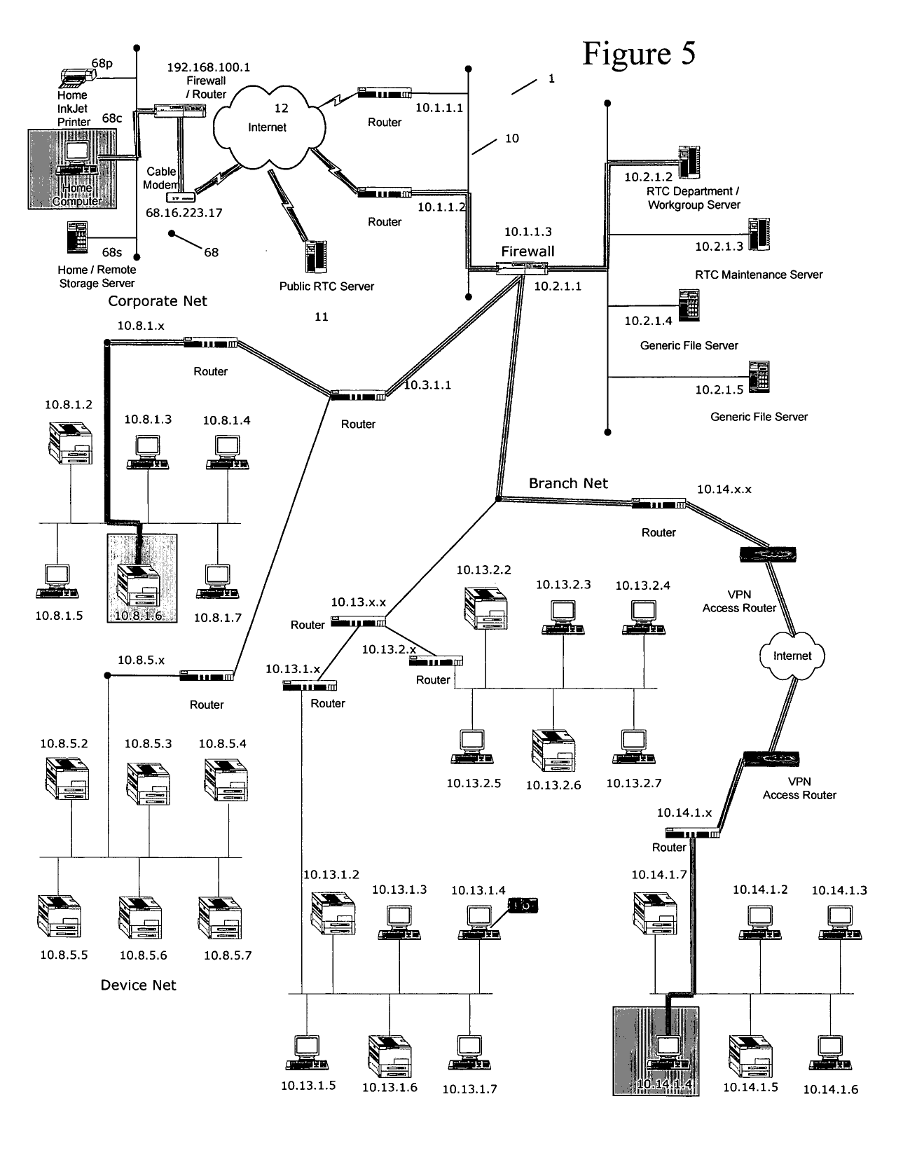

FIG. 5 illustrates an example of performing the discovery process of the present invention. Briefly, FIG. 5 depicts a scenario where a user discovers a particular real-time communication services server, adds real-time communication protocol enabled devices to the user's buddy list, and then performs an operation with one of the added real-time communication protocol enabled devices.

In more detail, a user is situated at user device 10.14.1.4 and wishes to add a remote printer to the user's buddy list. For example, the user may be located at the user' desk at work and would like to print a document on a printer, where the printer is real-time communication protocol enabled, located at a location remote from the user's desk, i.e., another building.

In order to discover any remotely located real-time communication protocol enabled printers, the user initiates a device discovery process, discovers RTC Department/Workgroup Server 10.2.1.2, and then logs onto the RTC Department/Workgroup Server 10.2.1.2. Once the user has logged on, the user then retrieves real-time communication protocol enabled device information from the RTC Department/Workgroup Server 10.2.1.2, including information regarding printer 10.8.1.6. Printer 10.8.1.6 would be added to the user's buddy list, and the user would then be able to select printer 10.8.1.6 from the buddy list and initiate a printing operation to printer 10.8.1.6.

It is to be understood that the above described functions of the present invention can be achieved by a method in which a storage medium is supplied to a system or device, the storage medium having computer-executable process steps for realizing the above described functions, and a computer (CPU or MPU) for the system or device that reads the computer-executable process steps stored in the storage medium and executes them.

In this case, the computer-executable process steps read from the storage medium executes the functions of the above described embodiments. Thus, the computer-executable process steps or the storage medium storing the computer-executable process steps therein constitute the present invention.

As a storage medium for supplying the computer-executable process steps, for example, a floppy disk, a hard disk, an optical disk, a magneto-optical disk, a CD-ROM, a CD-R, a magnetic tape, a non-volatile memory card, a ROM, any other applicable storage medium can be employed.

When the computer-executable process steps read by the computer are executed, not only are the above described functions of the embodiments realized, but also an operating system working on the computer may carry out part or all of the actual processing that realizes the functions of the above described embodiments.

The computer-executable process steps read from the storage medium may be written to a memory provided on a function-extension board inserted into the computer, of a function-extension unit connected to the computer, and a CPU provided on the function-extension board or unit carries out part of all of the actual processing that realizes the functions of the above described embodiments.

While the invention is described above with respect to what is currently its preferred embodiment, it is to be understood that the invention is not limited to that described above. To the contrary, the invention is intended to cover various modifications and equivalent arrangements within the spirit and scope of the appended claims.

What is claimed is:

1. A method for discovering real-time communication protocol enabled devices, comprising:
discovering at least one real-time communication server;
logging onto the at least one real-time communication server;
retrieving real-time communication protocol enabled device information from the real-time communication server; and
automatically adding the retrieved real-time communication protocol enabled device information to a real-time communication protocol contact collection.

2. A method according to claim 1, wherein discovery of the at least one real-time communication server comprises looking up the at least one real-time communication server in a directory service.

3. A method according to claim 1, wherein discovery of the at least one real-time communication server comprises passively observing network traffic to look for real-time communication protocol traffic.

4. A method according to claim 1, wherein discovery of the at least one real-time communication server comprises attempting to logon to servers within an IP address set and receiving a properly formed rejection notice.

5. A method according to claim 1, wherein discovery of the at least one real-time communication server comprises sending a data packet to a server, wherein the data packet is directed to the port on the server associated with real-time communication protocols.

6. A method according to claim 1, wherein retrieving the real-time communication protocol enabled device information comprises retrieving only device information for those devices that information retrieval is allowed.

7. A method according to claim 1, wherein the retrieved real-time communication protocol enabled device information includes a real-time communication protocol contact name.

8. A method according to claim 7, wherein the real-time communication protocol enabled device information is added to the real-time communication protocol contact collection and the associated real-time communication protocol contact name is added to a buddy list for a default period of time.

9. A method according to claim 8, wherein the default period of time is modifiable.

10. A method according to claim 8, wherein the real-time communication enabled device information is removed from the real-time communication protocol contact collection and the associated real-time communication protocol contact name is removed from the buddy list upon expiration of the default period of time.

11. A method according to claim 8, wherein the real-time communication enabled device information is removed from the real-time communication protocol contact collection and the associated real-time communication protocol contact name is rendered inaccessible from the buddy list upon expiration of the default period of time.

12. A method according to claim 8, further comprising performing a desired operation with at least one real-time communication protocol enabled device whose real-time communication protocol contact name has been added to the buddy list.

13. A method according to claim 12, wherein the desired operation includes printing, faxing, scanning, and data storage.

14. A method according to claim 12, wherein performance of the desired operation is restricted.

15. A method according to claim 14, wherein the operation restrictions include data volume, page count, access count, and time-of-day.

16. Computer-executable process steps for implementing the method for discovering real-time communication protocol enabled devices specified in claim 1.

17. Computer-readable storage medium for storing the computer-executable process steps specified in claim 16.

18. A system for discovering real-time communication protocol enabled devices, comprising:
means for discovering at least one real-time communication server;
means for logging on to the at least one real-time communication server;
means for retrieving real-time communication enabled device information from the real-time communication server; and
means for automatically adding the retrieved real-time communication enabled device information to a real-time communication protocol contact collection.

19. A system according to claim 18, wherein in retrieving the real-time communication protocol enabled device information comprises retrieving only device information for those devices that information retrieval is allowed.

20. A system according to claim 18, wherein the retrieved real-time communication protocol enabled device information includes a real-time communication protocol contact name.

21. A system according to claim 20, wherein the real-time communication protocol enabled device information is added to the real-time communication protocol contact collection and the associated real-time communication protocol contact name is added to a buddy list for a default period of time.

22. A system according to claim 21, wherein the default period of time is modifiable.

23. A system according to claim 21, wherein the real-time communication enabled device information is removed from the real-time communication protocol contact collection and the associated real-time communication protocol contact name is removed from the buddy list upon expiration of the default period of time.

24. A system according to claim 21, wherein the real-time communication enabled device information is removed from the real-time communication protocol contact collection and the associated real-time communication protocol contact name is rendered inaccessible from the buddy list upon expiration of the default period of time.

25. A system according to claim 21, further comprising performing a desired operation with at least one real-time communication protocol enabled device whose real-time communication protocol contact name has been added to the buddy list.

26. A system according to claim 25, wherein the desired operation includes printing, faxing, scanning, and data storage.

27. A system according to claim 25, wherein performance of the desired operation is restricted.

28. A system according to claim 27, wherein the operation restrictions include data volume, page count, access count, and time-of-day.

29. A method for populating a buddy list corresponding to a real-time communication protocol contact collection, comprising:
adding a real-time communication protocol contact name to the buddy list; and
assigning a use restriction to the real-time communication protocol contact name

30. A method according to claim 29, wherein the use restriction includes a default period of time, wherein the real-time communication protocol contact name is automatically removed from the buddy list upon expiration of the default period of time.

31. A method according to claim 30, wherein the default period of time is modifiable.

32. A method according to claim 29, wherein the use restriction includes a default period of time, wherein the real-time communication protocol contact name is automatically rendered inaccessible from the buddy list upon expiration of the default period of time.

33. A method according to claim 32, wherein the default period of time is modifiable.

34. A method according to claim 29, wherein the real-time communication protocol contact name corresponds to a real-time communication protocol enabled device.

35. A method according to claim 34, wherein the use restriction includes restricting an operation to be performed with the real-time communication protocol enabled device.

36. A method according to claim 35, wherein the operation restriction includes data volume, page count, access count, and time-of-day.
